(19) United States
(12) Patent Application Publication
(10) Pub. No.: US 2013/0071609 A1
(43) Pub. Date: Mar. 21, 2013

(54) Cushioning structure

(71) Applicants: Robert Masse, Apollo Beach, FL (US); Richard A. McKinney, Apollo Beach, FL (US); Barbara McKinney, Apollo Beach, FL (US)

(72) Inventors: Robert Masse, Apollo Beach, FL (US); Richard A. McKinney, Apollo Beach, FL (US); Barbara McKinney, Apollo Beach, FL (US)

(73) Assignee: MitiGator, LLC

(21) Appl. No.: 13/200,140

(22) Filed: Sep. 19, 2011

(51) Int. Cl. B32B 3/12; B32B 3/24; B32B 3/20

(52) U.S. Cl. 428/117; 428/116; 428/131

(57) ABSTRACT

A cushioning structure is adapted to support a ioad and to reduce stresses on the load as the result of externally applied impact forces. The cushioning structure comprises an impact energy absorbing layer adapted to be placed between the load and the applied impact energy. The cushioning structure is configured such that the impact energy absorbing layer comprises a plurality of cells of a pliable material, and wherein at least some of said cells are in fluid communication with adjacent cells to provide a valved fluid transfer between said cells, and further wherein the means for effecting valved transfer between cells comprises a venturi valve.

### FIELD OF THE INVENTION

This invention relates generally to the field of impact absorption and mitigation and more particularly to improved impact mitigation to minimize injury from potentially injurious externally applied forces.

### BACKGROUND OF THE INVENTION

Many activities engaged in today involve “pulse” type impacts which can cause injury to the participant many of which can result in serious spinal cord and cranial injuries. These injuries are the result of an impact wherein the participant receives a “hard landing”. Exemplary of such “hard landing” impacts are airplane/helicopter crashes, blasts from improvised explosive devices during military combat, motor boat and automobile racing and automobile crashes and all terrain vehicles, to name a few. Additionally, participants are subject to potentially injurious impacts while engaging in running (cartilage damage and knee injuries), as well as contact sports such as football and hockey. Injuries can also be sustained on farm and construction equipment as well as gravitationally based amusement park rides.

For example, when an aircraft such as a helicopter experiences power reduction and/or loss and lands, significant forces are transmitted to the passengers and crew. Research has shown that spinal injuries can be expected when forces exceed 9.5 Gs which results in 2500 lbs of spinal loading. When the spine suffers an impact injury, the injured party may become permanently or temporarily disabled to varying degrees, but the economic losses to the employer can also be substantial. For example, a helicopter or jet pilot represents a multi-million dollar investment when all of the training costs and experience are considered. Further, manned military vehicles are designed for force protection and not for comfort. As a result, the ride is rough and, depending on terrain, passengers are bounced around and back injuries, while not permanently disabling, are common and may render a soldier out of action for some period of time. On a more serious note, when a military vehicle is subjected to one or more explosions from improvised explosive devices (IEDs), force protection is of the utmost importance. Blasts from IEDs and land mines are two of the most common types of attacks on today's military personnel. IED and mine blasts, constant or single impacts, shocks or vibrations can cause fatigue, reduced proficiency, pain, injuries, and death.

With respect to military applications, the focus on troop protection in the field is continually evolving as the enemy continues to improve their own tactics. More specifically, the enemy's devices of destruction are getting smaller, more skillfully concealed and are being constructed using higher yielding explosives. The evolution of these devices demonstrates the resourcefulness of the enemy and their desire to kill the maximum number of troops. As a result, our means of force protection must continually improve to stay ahead of our enemies.

In view of the foregoing it is an object of the present invention to provide a cushioning structure that is an improvement over the available prior art devices.

Another object of the present invention it to provide a cushioning device that minimizes impact injuries by dissipating and absorbing the applied impact energy before it is transmitted to the load or human body where it can cause injury.

A further object of the present invention is to provide a cushioning device that improves the survival rate of persons involved in aircraft crashes and IED detonations.

Still another object of the present invention is to provide a cushioning structure that is a passive device.

Yet another object of the present invention is to provide a cushioning structure that quickly dissipates the absorbed forces, returns to its original shape and is capable of absorbing multiple shocks.

A still further object of the present invention is to provide a cushioning structure that is relatively inexpensive and easy to install.

### SUMMARY OF THE INVENTION

A cushioning structure is adapted to support a load and to reduce stresses on the load as the result of externally applied impact forces. The cushioning structure comprises an impact energy absorbing layer adapted to be placed between the load and the applied impact energy. The cushioning structure is configured such that the impact energy absorbing layer comprises a plurality of cells of a pliable material, and wherein at least some of said cells are in fluid communication with adjacent cells to provide a valved fluid transfer between said cells, and further wherein the means for effecting valved transfer between cells comprises a venturi valve.

### BRIEF DESCRIPTION OF THE DRAWINGS

FIG. 1 is a perspective view, partially broken away of a section of the cushioning structure according to the present invention.

FIG. 2 is an end view of a section of the cushioning structure according to the present invention taken along line 2-2 of FIG. 1.

FIG. 3 is a perspective view, partially broken away of a section of the cushioning structure according to the present invention taken from a different angle from that of FIG. 1.

FIG. 4 is an end view of a section of the cushioning structure according to the present invention taken along line 4-4 of FIG. 3.

FIG. 5 is a perspective view, partially broken away of a section of the cushioning structure according to the present invention taken from a different angle from that of FIGS. 1 and 3.

FIG. 6 is an end view of a section of the cushioning structure according to the present invention taken along line 6-6 of FIG. 5.

FIG. 7 is a schematic view illustrating the distribution of the impact forces on the cushioning structure according to the present invention.

FIG. 8 is a schematic illustration of a Venturi or Venturi valve.

FIG. 9 is a schematic illustration showing the structure of one embodiment of the Venturi valve according to the present invention.

### DETAILED DESCRIPTION OF A PREFERRED EMBODIMENT OF THE BEST MODE OF CARRYING OUT THE INVENTION

The foregoing and other advantages of the invention will become apparent from the following disclosure in which preferred embodiments of the invention are described in detail and illustrated in the accompanying drawings. It is contemplated that variations and structural features and arrangement of parts may appear to the person skilled in the art, without departing from the scope or sacrificing any of the advantages of the invention which is delineated in the included claims

For the sake of clarity, in the discussion that follows, impact forces will be described in relation to the “body” as in the body of a person. Notwithstanding the foregoing, the present invention will direct impact forces away from any object that acts as a load on the cushioning structure.

Referring to Figures, the cushioning structure of this invention indicated generally at 10 includes an impact energy absorbing layer or “waffle” 20, a lower membrane 30 and an upper membrane 40.

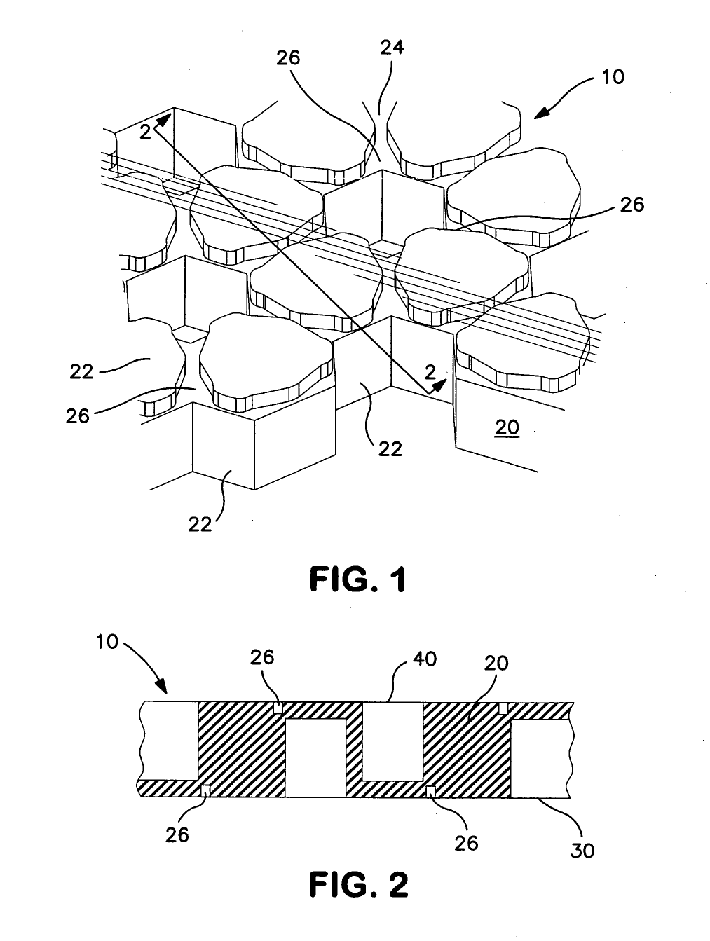

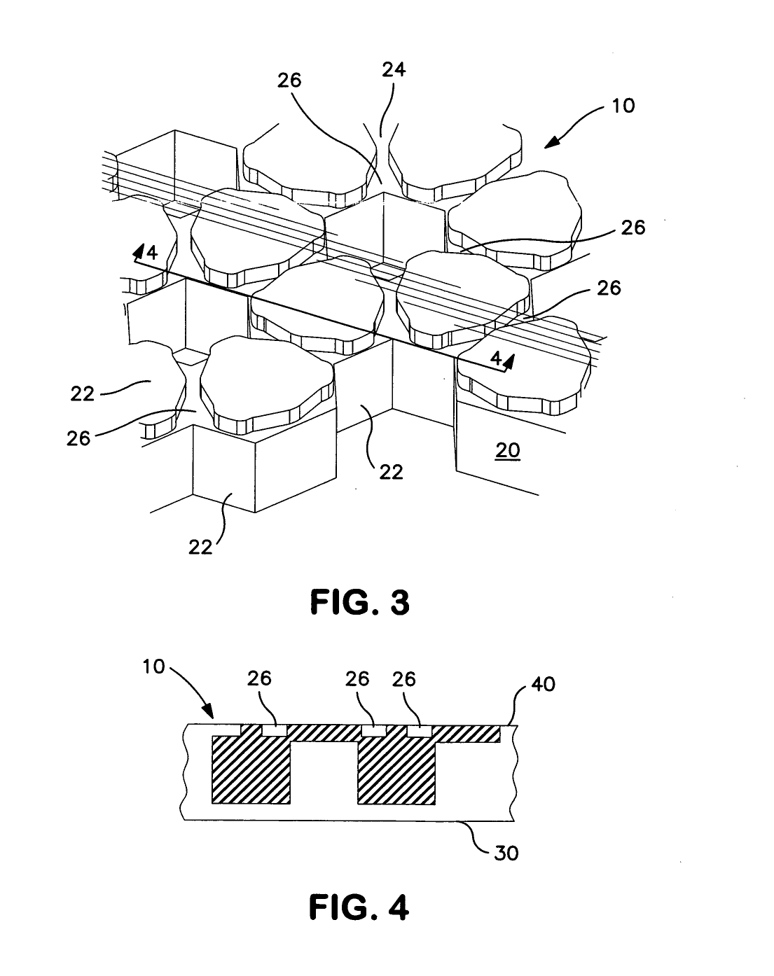

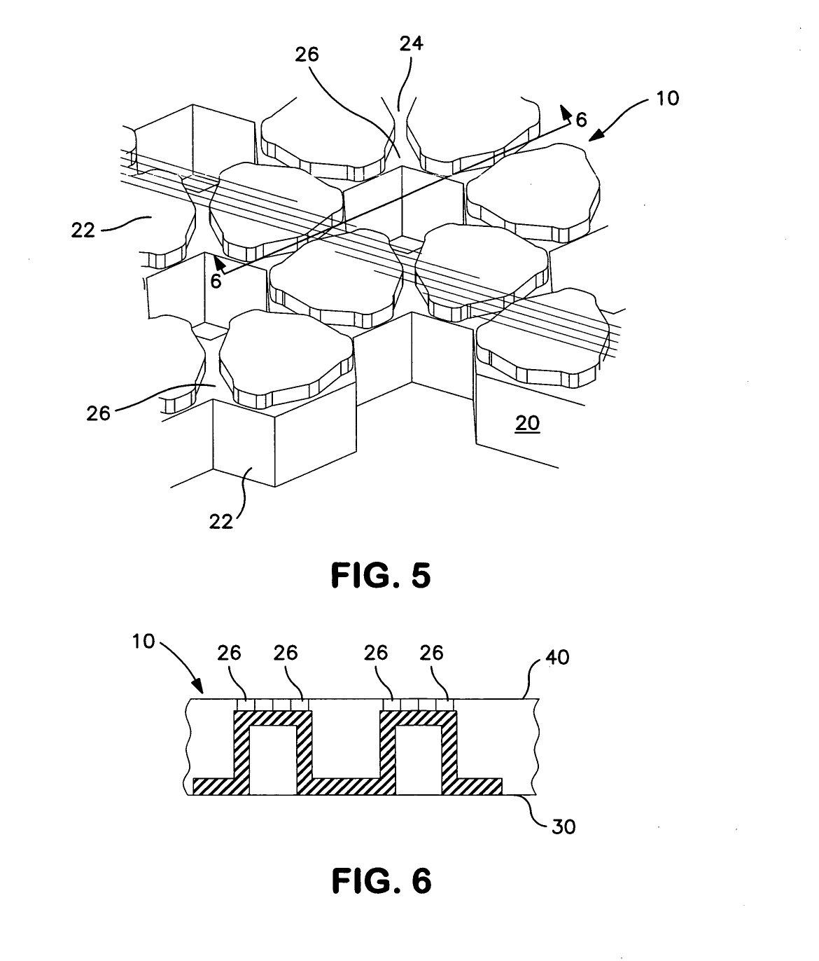

Turning now to waffle 20, it is a substrate approximately one (1) inch thick (which may vary depending upon specific application) of Urethane® molded according to conventional techniques in a ⅜ inch mold. Exemplary of the type of Urethane® employed is the F-31 FR A/B Fire Retardant (30 shore) available from BJB Enterprises, Inc. of Tustin, Calif. The waffle 20 includes a plurality of hexagonal shaped cells 22 arranged in a generally hexagonal or “honeycomb” pattern and having substantially vertical side walls as illustrated in the figures. In each hexagonal pattern cells 22 are one of two types. First, every other cell 22 is solid Urethane® which acts to provide support, mainly to the static load. Next, the remaining three cells 22 are hollow having an opening facing a first direction and having a solid bottom such that the center hexagonal cell 22 formed by the aforementioned “ring” is open in the opposite direction. The use of hexagonal cells provides a unique design which is identical when viewed from above or below. In the event of an impact, the cushioning structure 10 uses cells 22 and channels 24 to direct impact force away from the body. It does this by absorbing the impact and channeling the forces and energy across over 4,000 surfaces per square foot. Through the use of an encapsulating layer, trapped air or fluid, is trapped and funneled through a series of sophisticated channels 24, FMT (Fluid Manipulation Technology), which dampens the transmitted energy or “redirects” it laterally around the body as shown in FIG. 1.

As best illustrated in FIGS. 1,3,5 the waffle 20 further includes a confining layer or membrane 30 that is in overlying contacting relation with the lower surface and a second confining layer or membrane 40 in overlying contacting relation with the upper surface of the impact energy absorbing layer that “seals” in the air. The respective first and second confining layers 30, 40 are composed of Urethane®, available from Steven's Urethane and adhered to the waffle 20 by means of adhesives, or other methods such as heat sealing, commonly known to those skilled in the art.

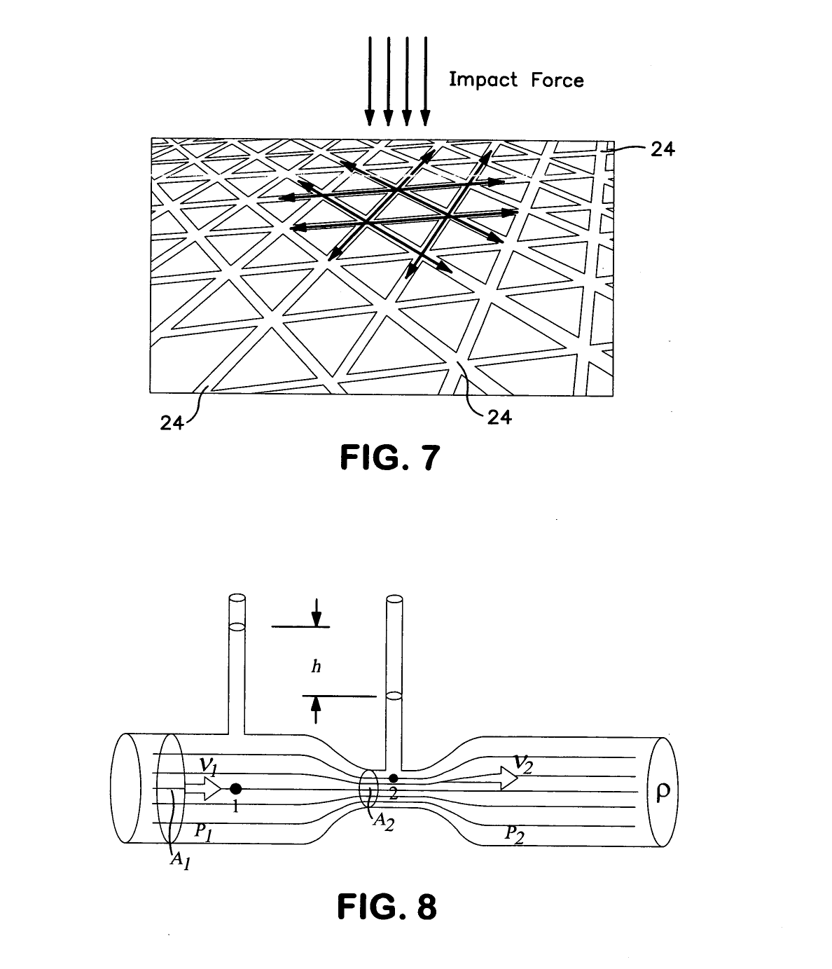

FIG. 7 illustrates what occurs within the cushioning structure 10 when subjected to an impact. The air trapped is “pushed” through the channels 24. The speed with which that air moves through the channels 24 is controlled such that the air will take the path of least resistance and therefore flow in every direction that is not blocked due to the deformation of the waffle during the impact event. The apparatus according to the present invention may be manufactured from a variety of materials and thickness, depending on the specific application and the types of external forces applied the weight of the body and the comfort requirements as defined by the user.

The cushioning structure includes a venturi valve or venturi 26 positioned between each adjacent hexagonal unit. Each venturi valve is formed on three sides by the waffle and the forth side is formed by the respective confining layer, 30, 40. The venturi valve 26 causes a reduction in fluid pressure, in this case air, and comprises constricting the channel 24 of the valve at the center point which creates a higher pressure on one side of the constricted channel and a lower pressure on the opposite side as shown in FIG. 8.

The laws governing fluid dynamics indicate that fluids velocity must increase through the section of constriction in order to satisfy the conservation of mass, while its pressure must decrease in order to satisfy the conservation of energy. Referring to FIG. 8, using Bernoulli's equation, assuming that the air is considered incompressible, the drop in pressure (P1−P2) at the constriction would be:

$$( \frac{ρ}{2} ) ( {v}_{2}^{2} - {v}_{1}^{2} )$$

where ρ is the density of the fluid, ν₁ is the slower moving fluid velocity where the channel is wider, and ν₂ is the faster moving fluid velocity where the channel is narrower. Density is assumed to remain constant and air is considered to be incompressible in this example. The Bernoulli's principle, which relates the pressure pᵢ of fluid to its velocity v_{i′} i=1, 2

$$p 1 + ( \frac{ρ}{2} ) {v}_{1}^{2} = p 2 + ( \frac{ρ}{2} ) {v}_{2}^{2}$$

If the air moving through the narrower section of the channel 24 is moving at a rate faster than 220 mph, then the air would be considered to be compressible. If this occurs, the narrowed channel 24 will act as a de Laval nozzle. A de Laval nozzle, or convergent-divergent nozzle, is considered to be a tube, or in this case, the channel, with a pinched section in the middle, which is how the enhancement was designed. The de Laval nozzle was used to accelerate hot, pressurized gas achieving supersonic speed and to shape the exhaust flow to maximize direct kinetic energy. A de Laval nozzle will only “choke” at the pinched section if the pressure and mass flow through the nozzle is sufficient to reach sonic speeds, otherwise, supersonic flow in not achieved and the nozzle will act as a Venturi Tube.

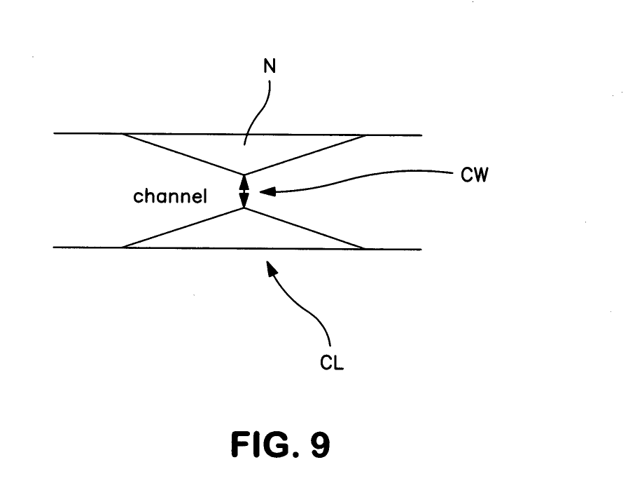

The nozzle is designed to take into account the various cell-channel designs due to the different material thickness. By designing the nozzle in this manner, the enhancement can be applied to any new design with little engineering modifications and the ability to apply the changes to any molder supplying the parts for production, as highlighted in FIG. 9. In the illustrated embodiment the channel width is 0.140 inch to 0.160 inch (5.4 Deg draft), yielding a venturi of 0.0466 inch wide at the top and 0.0533 inch at the bottom based on draft angles. The length of the channel is 0.5077 inch, yielding a venturi length of 0.253 inch. As illustrated, there is a small radius at each end of the venturi on the order of 0.030 inch to 0.047 inch.

It is herein understood that although the present invention has been specifically disclosed with the preferred embodiment, modifications and variations of the concepts herein disclosed may be resorted to by those skilled in the art. Such modifications and variations are considered to be within the scope of the invention and the appended claims.

That which is claimed is:

1. A cushioning structure adapted to support a load and to reduce stresses on the load as the result of externally applied impact forces and comprising:
an impact energy absorbing layer adapted to be placed between the load and the applied impact energy, and wherein the impact energy absorbing layer comprises a plurality of cells of a pliable material, and wherein at least some of said cells are in fluid communication with adjacent cells to provide a valved fluid transfer between said cells, and further wherein said valved transfer between cells comprises a venturi valve.

2. The cushioning structure according to claim 1 wherein said cells in said impact energy absorbing layer are constructed and arranged in a honeycomb type arrangement.

3. The cushioning structure according to claim 2 wherein preselected cells are solid to provide structural support to the cushioning structure, preselected cells are hollow and are adapted to receive displaced fluid upon the application of an applied impact force.

4. The cushioning structure according to claim 3 wherein said impact energy absorbing layer further includes an upper surface and a lower surface, and wherein preselected of said cells are oriented such that said venturi valves are positioned in the lower surface and preselected of said cells are oriented such that said venturi valves are positioned in the upper surface.

5. The cushioning structure according to claim 4 further including an upper membrane in contacting overlying relation with the upper surface that acts to seal the cells in the upper surface and allows for fluid communication between said preselected cells forming venturi valves; and
a lower membrane in contacting overlying relation with the lower surface that acts to seal the seals on the lower surface and allows for fluid communication between said preselected cells forming venturi valves

6. A cushioning structure adapted to support a load and to reduce stresses on the load as the result of externally applied impact forces and comprising:
an impact energy absorbing layer having an upper surface and a lower surface and wherein said impact absorbing layer comprises a plurality of cells of a pliable material, said cells being arranged in a honeycomb type arrangement and wherein a preselected number of cells are oriented such that the upper surface of preselected adjacent cells are in fluid communication with each other and form a venturi valve, the lower surface of other adjacent cells are in fluid communication with each other and form a venturi valve and still other cells are structural and provide support for the applied load; and
an upper membrane in contacting overlying relation with the upper surface that acts to seal the cells in the upper surface and allows for fluid communication between said preselected cells forming venturi valves; and
a lower membrane in contacting overlying relation with the lower surface that acts to seal the cells on the lower surface and allows for fluid communication between said preselected cells forming venturi valves;
whereby the energy of an externally applied impact force is dissipated in and absorbed by the energy absorbing layer and damage to the load is reduced.

7. The cushioning structure according to claim 6 wherein said cells are constructed and arranged in a repeating generally hexagonal pattern and further, wherein each of said hexagonal cell patterns comprises six cells oriented in a first direction and wherein adjacent cells alternate between hollow and solid and further, wherein the center cell defined by said surrounding cells is oppositely oriented and defines a space into which fluid flows upon application of a load.

8. The cushioning structure according to claim 7 wherein the upper surface of preselected adjacent cells are constructed and arranged as a venturi valve.

9. The cushioning structure according to claim 8 wherein said cells have substantially vertical side walls and substantially planar respective upper and lower surfaces.

10. The cushioning structure according to claim 7 wherein each cell has common side walls with three other cells.
